(19) United States
(12) Patent Application Publication
(10) Pub. No.: US 2008/0228773 A1
(43) Pub. Date: Sep. 18, 2008

(54) APPARATUS AND METHOD FOR DATA INPUT DEVICE

(75) Inventors: James W. Stewart, E. Syracuse, NY (US); Garrison L. Gomez, Marietta, NY (US); Thomas J. Kozlol, Camillus, NY (US)

Correspondence Address: STEIN, MCEWEN & BUI, LLP, 1400 EYE STREET, NW, SUITE 300, WASHINGTON, DC, 20005, US

(73) Assignee: HAND HELD PRODUCTS, INC., Skaneateles Falls, NY (US)

(21) Appl. No.: 11/686,014

(22) Filed: Mar. 14, 2007

(51) Int. Cl. G06F 17/00

(52) U.S. Cl. 707/10; 707/E17.032

(57) ABSTRACT

A client apparatus to receive scan data. The client apparatus comprises configuration files including a plurality of settings to control operations of the client apparatus, logic to receive scan data and to request web pages from a web server using the scan data and the settings in the configuration files. The configuration files separate the functionality of the client apparatus from the content of the web pages so that neither the configuration files nor the web pages depend on the particular platform or hardware setup of the client apparatus.

### BACKGROUND OF THE INVENTION

1. Field of the Invention

Aspects of the present invention relate to input devices for data, and, more particularly, to methods and apparatuses to separate the hardware functionality of an input device from an application.

2. Description of the Related Art

Businesses have recently begun to deploy automated devices to assist customers. For example, department stores and other retailers have begun placing computing devices throughout their store to interact with customers. These computing devices typically contain a display mechanism as well as data input mechanism(s) that enable the customer to input data. These input mechanisms may be an integrated barcode scanning or imaging device, an integrated magnetic stripe reading device, or other data capture-input technology. Customers can use the computing devices for a variety of purposes, such as to obtain price information about products on display by scanning a bar code on the product. The computing device can also display additional information, such as a layout of the store, items on sale, special offers, or information available only to members of a loyalty club, etc.

In order to minimize the cost associated with implementing the described functionality on a computing device, businesses need to utilize an application development methodology that allows for rapid application development, easy updates, and easy integration into the targeted computing device. Web applications may be used for this purpose. Web applications include a collection of web pages through which the customer interacts with the computing device. With web applications, much of the processing and data manipulation required can be performed by a central server. The computing device does not need to store any information in its own memory; instead, the computing device can request necessary information from the server. Thus, for example, when product information is updated, necessitating a change in the web application, the business needs to update only the web application on the server, not all the computing devices in the store. In addition, web applications are built around commonly known, easy to use technologies. In order to use bar code scanning or other input technology in the web application, a mechanism or methodology is needed that allows for the hosting of a web based application on the computing device or other data terminal and also provides integration of the data input functionality to the hosted web application.

Several methodologies are currently in use for computing devices or handheld mobile devices for use with web applications that incorporate bar code scanning (or other data input functionality). One methodology involves a proprietary browser to display web application content received from the server on the computing device's display. With a proprietary browser, the computing device manufacturer designs a custom Web browser tailored to the particular computing device hardware. Since the interaction between the hardware and the browser is built into the browser, the proprietary browser is platform specific. Changing the hardware the browser runs on (for example, upgrading to a new computing device) requires designing a new browser to incorporate the changed hardware functionality.

Another solution encapsulates the interaction between the hardware and the web application via an ActiveX control. ActiveX is a Microsoft technology that allows application developers to embed a piece of software code into a Web page that makes use of an Active X control resident on the hardware platform. In the case of computing devices, the web page is displayed to the customer using a browser, such as Internet Explorer, on the computing device. The code embedded in the web page uses the ActiveX control to access the scanning functionality on the computing device to retrieve the input from the input device before making the next request to the web server, which includes the input from the input device. The web application developer must know the specific functional details of the Active X control, which by their nature are specific to the hardware platform. For this reason, the use of ActiveX controls causes many of the same problems as the proprietary browser. If the hardware changes and the ActiveX control changes, the code in the web page must be rewritten to accommodate the change.

What is needed is a way to separate the hardware scanning or data input functionality from the web application, so that the web application developer does not need to have specific knowledge of the scanning or data input functionality of the terminal therefore eliminating the need to add additional code to the web application that incorporates hardware specific functionality into the application. Additionally, this means that the web application (or its components) do not need to be rewritten or modified every time the hardware changes.

### SUMMARY OF THE INVENTION

Aspects of the present invention provide a web application separate from a particular hardware implementation or from a particular platform. The user of a computing device (such as a business) thus does not need to be aware of the particular hardware used. From the user's perspective, the web application will function regardless of the hardware used to run the web application.

Additional aspects of the present invention provide automation of common tasks. The container web application, or other components, may be automatically updated with newer versions present on the server. Automated setup and configuration may also be provided. Automatic failover in the event of an error in booting or loading a web page may also be provided.

According to an aspect of the present invention an apparatus is provided, comprising a container application to display web pages to a customer, to receive input from an input device, and to request web pages from a web server; and a plurality of configuration files each having user-configured settings to control the operation of the container application.

According to another aspect of the present invention, a method to display a web page is provided, the method comprising loading a web page received from a web server; determining if the web page has decode functionality enabled; enabling decode functionality if the web page has decode functionality enabled, based on information contained in a configuration file; and displaying the web page.

According to another aspect of the present invention, a method to provide information by separating platform-dependent functionality from plafform-independent functionality is provided, the method comprising decoding input from a customer, retrieving the name of a redirect page and query string parameters from at least one plafform-independent configuration file; constructing a URL query string using the name, the parameters, and the decoded input; and navigating to the constructed URL, wherein the web page addressed by the URL does not contain platform-dependent code.

According to another aspect of the present invention, there is provided a method to automatically update configuration files stored on a computer, the method comprising determining the location of updated configuration files based on information contained in existing configuration files; downloading the updated configuration files from a server listed in the existing configuration files; applying settings contained in the updated configuration files; and loading a web page based on information contained in the updated configuration files.

According to another aspect of the present invention, there is provided a computer readable medium comprising configuration files having a plurality of settings to control operation of a container application to receive scan input from an input device, to request web pages from a web server based on the scan input and the plurality of settings, and to display the web pages received from the server; wherein the configuration files separate the functionality of a client apparatus from the content of the web pages so that neither the configuration files nor the web pages depend on the platform or hardware configuration of the client apparatus.

According to another aspect of the present invention, there is provided a computer readable medium comprising configuration files having a plurality of settings to control operation of a container application to automatically download updated configuration files onto a computer.

According to another aspect of the present invention, there is provided a computer readable medium comprising configuration files having a plurality of settings to control operation of a decoding device to decode image data input by a user.

According to another aspect of the present invention, a system is provided comprising a web server to store a plurality of web pages and a client apparatus including a container application to receive input data and to request web pages from the web server and a plurality of configuration files having settings to control the inputting of data and the requesting of web pages, wherein the configuration files separate the functionality of the client apparatus from the content of the web pages so that neither the configuration files or not the web pages depend on the platform or hardware configuration of the client apparatus.

According to another aspect of the present invention, there is provided a client apparatus comprising a plurality of configuration files having settings to control operations of the client apparatus; logic to receive scan input from a customer, to determine the content of the settings in the configuration files, to construct a request for a web page using the information in the configuration file, and to request a web page using the constructed request; wherein the configuration files are independent of a particular platform supported by the logic and the hardware setup of the client apparatus.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an environment in which an embodiment of the present invention may be used;

FIGS. 2A, 2B, and 2C are views of a web application configuration file according to an embodiment of the present invention, FIG. 2D is a download (automatic setup/configuration) configuration file according to an embodiment of the present invention, and FIG. 2E is a decode configuration file according to an embodiment of the present invention;

FIG. 3A is a flowchart showing a page request operation according to an aspect of the present invention, FIG. 3B is a flowchart showing a decode handling operation according to an aspect of the present invention, and FIG. 3C is a flowchart showing handling an error in a page request operation according to an aspect of the present invention; and

FIG. 4A is a flowchart showing a startup operation according to an embodiment of the present invention and FIG. 4B is a flowchart showing handling an error in a startup operation according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

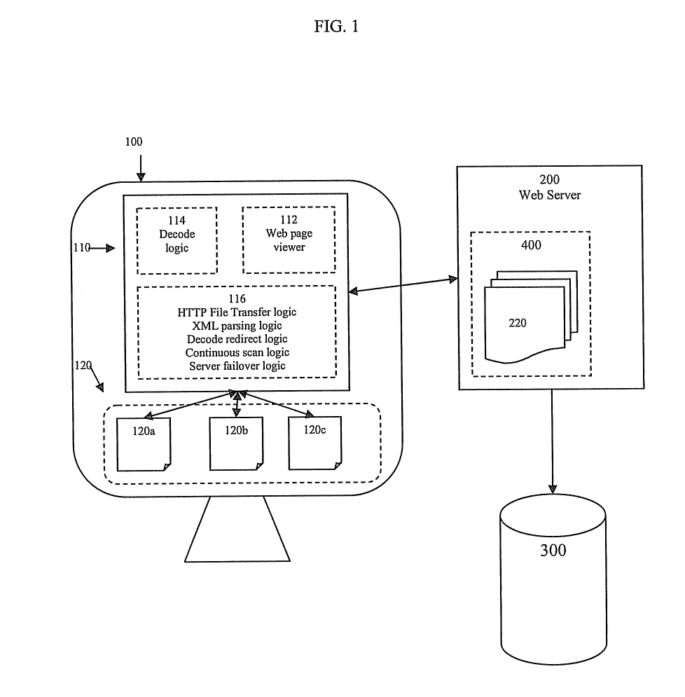

FIG. 1 shows a system according to an embodiment of the present invention. A computing device 100 communicates with a web server 200. The web server 200 may include a web site having a plurality of web pages 220. The web site displays information to a customer accessing the computing device 100. Information accessed by the web site may be stored in a data store 300. The web server 200 responds to requests from the computing device by accessing, as necessary, data stored in data store 300 and transmitting an appropriate response to the computing device 100.

The web server 200 may use any server technology, such as Microsoft Windows, Unix variants (such as Linux) or Mac OS X Server. Depending on the needs of a particular user, one, two, or any number of web servers 200 may be employed. Similarly, the data store 300 may be incorporated into the web server 200 or the system may have multiple data stores 300. The data store 300 may include a database in any format. A plurality of web pages 220 are stored on the web server 200. The web pages 220 are the interface between the customer and the system of FIG. 1. Here, “user” refers to the entity deploying the system, such as a retailer or other business. The “customer” is the individual interacting with the computing device 100.

The computing device 100 includes a container application 110 and a plurality of configuration files 120, such as a web application configuration file 120a, a download configuration file 120b, and a decode configuration file 120c. The container application 110 encapsulates a plurality of components: a web page viewer 112, decode logic 114 to decode an image received from the input device, and control logic 116 to control other operations of the container application 110. By separating each of these components, the operation of one component is hidden from the others. The container application 110 and the configuration files 120 may be written using any platform or framework, such as Microsoft™ Windows™ CE and the Windows™ .NET framework. Operations of the configuration files 120 and the components of the container application 110 are described in greater detail below.

The computing device 100 may also include various hardware and software components not shown, such as an input device to receive bar code input, a display, and a network connection. The input device may be configured to accept data in any form, such as manual input, bar codes, magnetic stripes (e.g., credit cards or loyalty cards), RF tags, or image data. The input device may be a conventional bar code scanner, a magnetic stripe reader, a button reader, an RF tag reader, a smart tag reader, a digital camera, or any device capable of receiving input data. The display may be any type of display, such as a touch display. The network connection may be wired, such as Ethernet, or wireless. According to other aspects of the invention, the computing device 100 may include additional hardware and/or software components. The computing device 100 may be a kiosk, a desktop computer, a handheld mobile device, or other type of device.

The web page viewer 112 displays the web pages 220 on the computing device 100's display. The web pages 220 are the customer's interface between the customer and the computing device 100, web server 200, and data store 300. The web pages 220 may make up a web application 400. The customer can use the web application 400 to obtain information about products and services offered by the user. The web application 400 may be designed by the user for the user's particular needs; thus, for example, one user may include web pages implementing a price check feature, while another may include a way for customers to swipe a loyalty card to see tailored offers. The web application 400 does not include any code to display web pages, decode data, or to request pages based on data received; these operations are instead performed by the components of the container application 110. Since hardware-specific code is included in the container application 110, this code does not need to be included in the web application 400. The user, therefore, does not need to develop any code to handle these functions. Furthermore, since (as described below) the particular page to request upon receiving decode data is defined in one of the configuration files 120, the user does not need to change the container application 110 when the user decides to change a name of a web page in the web site or to alter the web site's structure.

Returning to FIG. 1, the decode logic 114 controls operation of the input device in conjunction with the configuration files 120, such as the decode configuration file 120c. When the customer inputs data, such as a bar code, a magnetic strip, or image data, the decode logic receives the input from the input device and decodes the data into a format capable of being transmitted to the web server, such as a text format. The decode logic 114 may use information stored in decode configuration file 120c to determine how to decode the data or to determine user settings for behavior when decoding data (such as a beep to indicate a successful scan to the customer). The decode logic 114 includes all the hardware specific code needed to control the input device. The user does not need to modify the web application 400 if the hardware changes or if the decoder needs to decode data in a different format. Once the decode logic 114 decodes the data, the decode logic passes the data to the control logic 116 for additional processing.

The control logic 116 controls additional operations of container application 110 in conjunction with the configuration files 120. The control logic 116 includes HTTP file transfer logic, XML parsing logic, continuous scan logic, decode redirect logic, and failover logic. The HTTP file transfer logic is responsible for the automatic deployment of configuration files 120 to the device. The XML parsing logic controls interpreting the configuration files 120 to determine the settings contained in the configuration files 120. The continuous scan logic controls the input device to accept input continually, so that a customer may always input data to the computing device 100. Although the continuous scan logic may allow a user to input data at any time, the input may not have any effect, depending on the particular state of the computing device 100. For example, when the customer inputs a bar code while viewing a web page that does not need bar code data, nothing may happen. According to other aspects of the invention, the control logic 116 may include logic to control other operations of the container application 110 and/or the computing device 100.

The decode redirect logic controls operation of the container application 110 when the decoder logic 114 receives input data from the customer while the customer is viewing a page determined to need input data, as defined in one of the configuration files 120. The decode redirect logic uses the configuration files 120 to construct a redirect request to the web server. The redirect request includes the data input by the customer as well as the name of a web page, as defined by settings in the configuration files 120.

The failover logic includes logic to handle errors, such as when the container application 110 requests a web page not found on the web server 200 or when the container is unable to download a component during a boot or automatic update operation. According to other aspects of the invention, the control logic 116 may include logic to control other operations of the computing device 100 as well.

The logic contained in the control logic 116 is not part of the web application 400. As a result, the particulars of the implementation are shielded from the web application 400 and the user. The user does not, therefore, need to develop code to handle any of the operations controlled by the control logic 116. Instead, the user may focus on the web application 400. If the user were to install a new version of the logic, for example, when upgrading to a newer computing device, the user would not need to make any changes to the web application 400.

The configuration files 120 are a plurality of files containing user settings to control operation of the computing device 100 and the system shown in FIG. 1. The computing device 100 includes three configuration files 120: web application configuration file 120a, download configuration file 120b, and decode configuration file 120c. Each of the configuration files 120 contains different settings to control different operations of the container application 110. According to other aspects of the invention, computing device 100 may contain any number of configuration files 120.

The configuration files 120 may be stored in any file format. According to an embodiment of the invention, the configuration files are XML (extensible Markup Language) files. An XML file is a hierarchical list of user-defined elements and corresponding attributes. XML files can be edited in a XML-specific editor or even in a general-purpose text editor. The user can thus easily customize the settings included in the configuration files 120.

The configuration files 120 control various operations of the system shown in FIG. 1 and separate the user-defined responses to particular events from the hardware and software. Thus, for example, a setting in one of the configuration files 120 can define which one of the web pages 220 to request when the user scans a bar code. Since this setting is in the configuration files 120 and not in the web application 400, if the user wants to change the web page that the web application 400 should request, the user only needs to edit the appropriate setting in the configuration files 120. In addition, the configuration files 120 also allow for automation of certain tasks. For example, the configuration files 120 can define a server where the computing device 100 can automatically download new or updated configuration files. The configuration files 120 may also define actions to take in the event of an error. If a requested web page is not found on the web server 200, a setting in one of the configuration files 120 can define an alternate document to be presented.

The configuration files 120 are not part of the container application 110. Instead, the configuration files 120 are stand-alone files. Since the configuration files 120 are not part of the container application 110, the contents of the configuration files 120 may be changed without changing the container application 110. The user does not, therefore, need to rewrite portions of the container application 110 each time a particular setting changes. In addition, the same configuration files may be used across a variety of computing devices 100 regardless of the underlying hardware. The configuration files 120 may also be downloaded from a central server and automatically updated independently of the container application 110, which may save time and bandwidth as the configuration files 120 are much smaller than the container application 110.

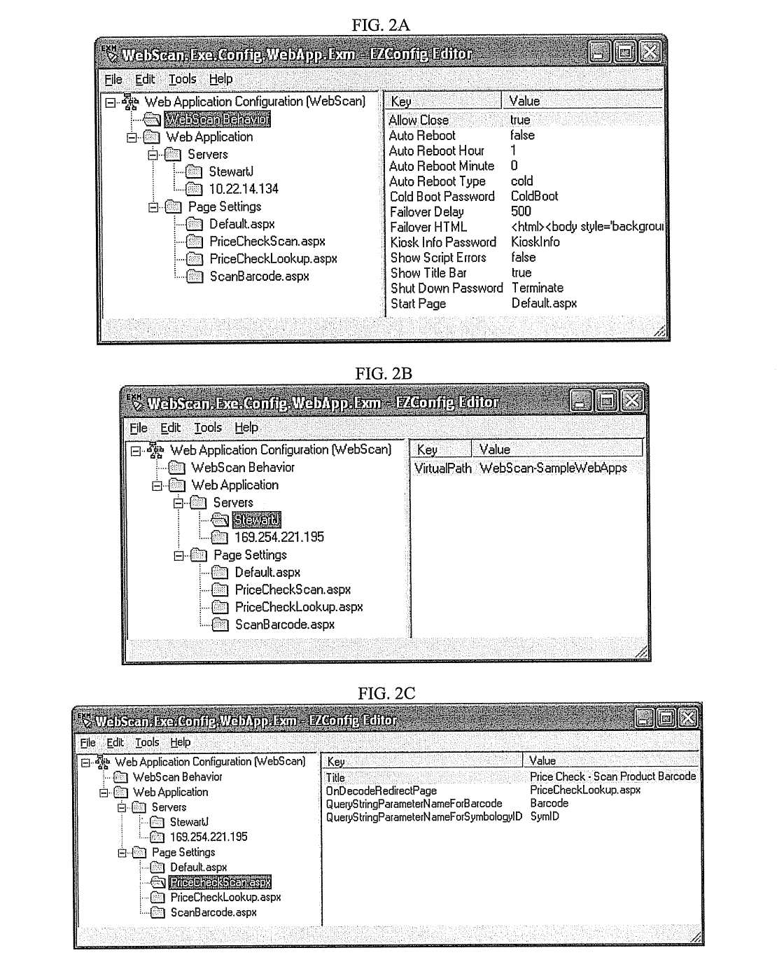

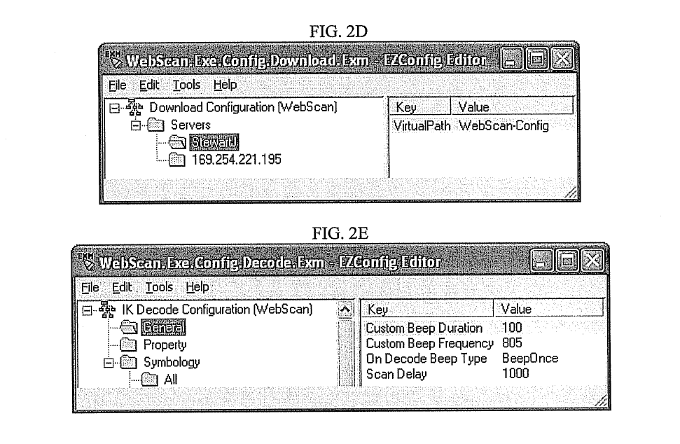

FIGS. 2A-2C, 2D, and 2E show three different configuration files according to an embodiment of the present invention. FIGS. 2A, 2B, and 2C are views of a web application configuration file 120a containing settings for the container application 110 and the web application 400. FIG. 2D shows a download configuration file 120b containing auto-update settings. FIG. 2E shows a decode configuration file 120c containing settings for decoding bar codes. Configuration files according to other aspects of the present invention may include different settings.

FIG. 2A illustrates a part of the web application configuration file 120a. The settings are divided into two main classifications: “WebScan Behavior” and “Web Application”. “Web Application” is itself divided into two sub-classifications: “Servers” and “Page Settings”. Configuration files according to other aspects may have a different organization scheme.

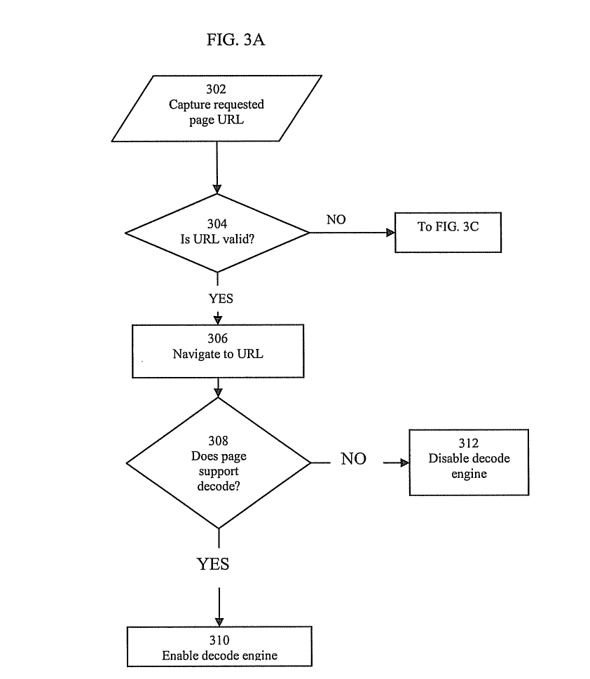

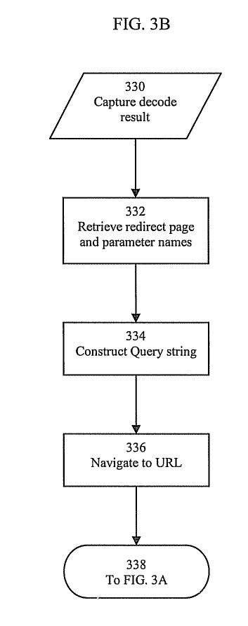

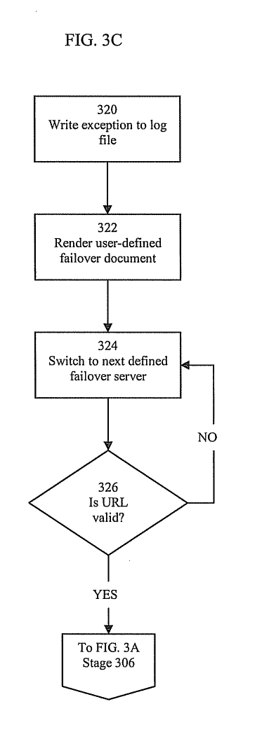

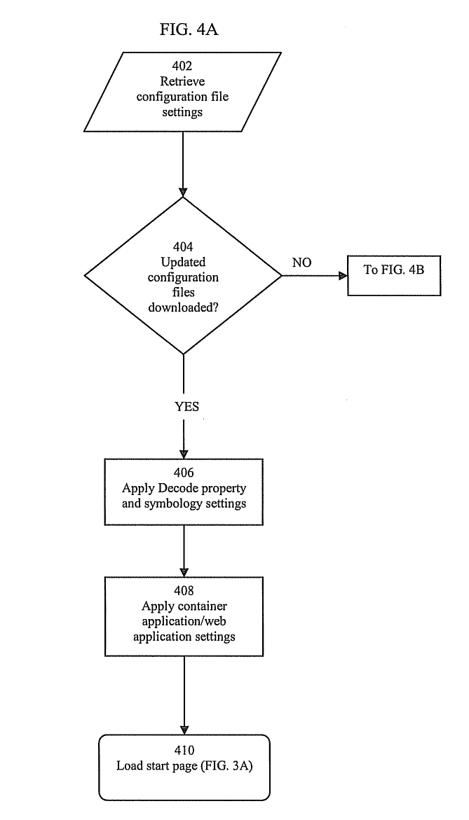

The settings listed under “WebScan Behavior”, shown in FIG. 2A, allow the user to change various attributes of the container application 110. In the embodiment shown in FIG. 2A, the container application 110 is called “WebScan”. The “Allow Close” setting determines whether the customer can close the container application 110. If the “Allow Close” setting is TRUE, as shown in FIG. 2A, the customer can close the container application 110. The “Auto Reboot” settings define whether the container application 110 automatically reboots the computing device 100, and, if so, at what time the reboot should occur and what kind of reboot should be performed. Various “password” elements define passwords which, when inputted by the user, will control the container application 110 to perform various actions. The passwords may be encoded and input as bar codes. For example, if the user scans a bar code corresponding to the password identified as the “Shut Down Password”, the container application 110 will control the computing device 100 to shut down. The “Failover” settings control error handling and are described below with respect to FIG. 3C. The “Show Script Errors” setting is a debugging setting that, if set to TRUE, will automatically display errors. “Show Title Bar” defines whether a window title bar will be displayed. Finally, “Start Page” defines the start (default) web page for the web application 400.

The settings listed under “Web Application”, shown in FIG. 2B, control operations of the web application 400 and may be separated into two sub-classifications, “Servers” and “Page Settings”. Under the “Servers” sub-classification, the user may list the servers where the container application 110 may request the web pages 220. The list may be in a priority order, so that if the first server in the list does not respond, the container application 110 requests the web pages 220 from the second server in the list, and so forth until the container application 110 receives a response. Each web server 200 in the list has one attribute, the “Virtual Path” attribute. The “Virtual Path” attribute defines the virtual path (address) of the web pages on the web server 200.

The “Page Settings” sub-classification, shown in FIG. 2C, defines behavior for the web pages 220 that comprise part of the web application 400. Not all web pages 220 need to have attributes defined in the web application configuration file 120a. For example, only the web pages 220 that require decode functionality or that have a title may have settings defined in the web application configuration file 120a. As shown in FIG. 2C, each of the web pages 220 has four attributes, “Title”, “OnDecodeRedirectPage”, “QueryStringParameterNameForBarcode”, and “QueryStringParameterNameForSymbologyID”. According to other aspects of the invention, each of the web pages 220 may have a different number of attributes.

The “Title” attribute defines the title of the web page. The title may be displayed on the title bar; if the “Show Title Bar” setting under “WebScan Behavior” is set to FALSE then the title may not be displayed. The “OnDecodeRedirectPage” defines the web page that the container application 110 will request once a successful decode is detected. Thus, if the user scans a bar code while the page is displayed, the container application will respond by requesting the web page indicated by the “OnDecodeRedirectPage” setting. The “QueryString . . . ” settings define the name of parameters used in constructing a query string as part of requesting a web page. The parameter names may be used by the web server 200 to determine what type of data has been transmitted. For example, bar code data may be transmitted using the parameter name “Barcode”, while data from a magnetic stripe (e.g., from a loyalty card) may be transmitted using the parameter name “Magnetic”. The process of requesting a web page is described below with respect to FIG. 3A.

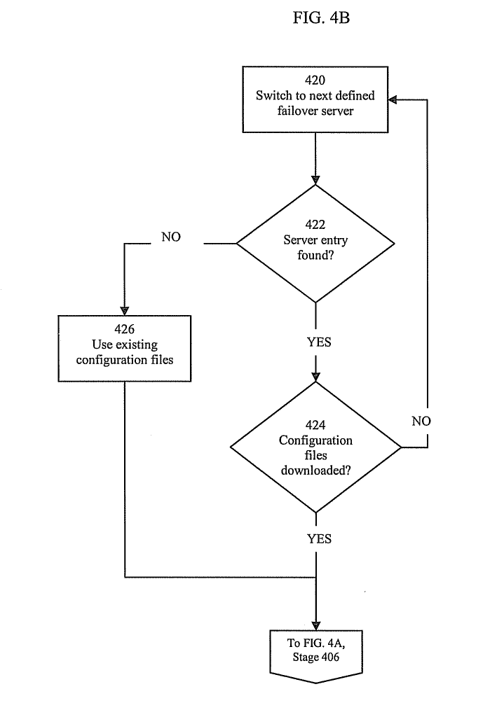

FIG. 2D shows the download configuration file 120b. The download configuration file 120b is a list of servers from which the container application 110 will download updated configuration files 120 when the container application 110 starts up. If the container application 110 cannot download all the configuration files 120 from the first server on the list, the container application 110 will attempt to download the configuration files 120 from the next server on the list and so on until the container application has either successfully downloaded the configuration files 120 or there are no more server entries, in which case the container application 110 may use the existing configuration files 120. For a download to be considered successful, the updated configuration files 120 should be downloaded as a set. This process is described below with respect to FIG. 4B. The container application 110 may also access servers in other orders as well.

FIG. 2E illustrates the decode configuration file 120c. The decode configuration file lists settings for the scanning hardware and the decode logic 114. These settings include the type of response to a successful scan (e.g., “beep once”, “double beep”, etc.), the length and frequency of a beep, and a delay between scan attempts. The settings may also include different settings for each type of bar code mapping (symbology). Bar codes are created using one of several different encoding schemes, called symbologies. The Universal Product Code used on consumer goods is an example of a commonly used bar code symbology. Each symbology supported by computing device 100 may have its own settings.

FIGS. 3A, 3B, and 3C describe a routine to request a web page according to an embodiment of the present invention. FIG. 3A describes a routine to load a web page. FIG. 3B describes a routine to request a web page upon receiving a scan input from a customer. FIG. 3C describes an error routine if the requested web page cannot be loaded, for example due to server error.

FIG. 3A is a routine to request a web page according to an embodiment of the present invention. At stage 302, the container application 110, using the control logic 116, requests a web page, such as “Default.aspx”. At stage 304, the container application 110 determines whether the request is valid. If the request is not valid, an error (failover) routine may occur, described below with respect to FIG. 3C. If the request is valid, the container application 110 navigates to the web page at stage 306. At stage 308, the container application 110 then determines whether the requested web page requires decode functionality. This information is stored in one of the configuration files 120, such as the web application configuration file 120a. The container application 110 reads the web application configuration file 120a and determines whether the web page is listed under the “Page Settings” sub-classification. If the web page is listed, and then decode functionality is required then and the decode logic 114 is enabled at stage 310. If the web page is not listed or there is no value entered for the OnDecodeRedirectPage setting, then decode functionality is not required and the decode logic 114 is disabled at stage 312. Other aspects of the invention may have other ways to determine whether a web page requires decode functionality. For example, a setting in the configuration files 120 may specify whether a web page requires decode functionality, or a tag in the web page may indicate whether the web page requires decode functionality.

FIG. 3B is a routine to request a web page in response to a customer's scan input. This routine may be performed when a web page requiring decode functionality is being displayed on the computing device 100. At stage 330, the decode logic 114 waits for the customer to input scan data. Scan data may be a bar code, magnetic stripe, or image data. Once the customer inputs scan data, the decode logic 114 captures and decodes the scan data and passes the decoded data to control logic 116. For example, the customer may scan a bar code encoded using a symbology called “abcd”; the data encoded by the bar code may be “0123456789”.

At stages 332 and 334, the control logic 116 retrieves information from the web application configuration file 120a and uses the retrieved information, along with the decoded data, to construct a request for a web page. The web page request is in the form of a redirect request for a Uniform Resource Locator (URL). URLs used for web page requests have the format http://www.example.com/virtualpath/PriceCheckLookup.aspx?query_string. The URL has three components that the control logic 116 needs to construct, based on information in the web application configuration file 120a. The first component is the server and virtual path, i.e., www.example.com/virtualpath. The control logic 116 retrieves the first server found in the “Server” list in the web application configuration file 120a and uses that information to determine the server component of the URL. Here, the first server in the list is “StewartJ” and the corresponding virtual path is “WebScan-SampleWebApps”. Accordingly, the first component of the URL would be StewartJ/WebScan-SampleWebApps/.

The second component in the URL is the filename. The control logic 116 looks in the web application configuration file 120a for the settings corresponding to the web page being displayed. For example, if the web page being displayed is “Default.aspx”, the control logic 116 looks under “Page Settings” for the settings corresponding to “Default.aspx”. Then, the control logic uses the value of the “OnDecodeRedirectPage” setting as the filename. For “Default.aspx”, the filename is “PriceCheckLookup.aspx”. Accordingly, the first two components of the URL would be StewartJ/WebScan-SampleWebApps/PriceCheckLookUp.aspx.

The third component of the URL is the query string. Query strings generally contain additional information used by the server. Here, the additional information may include the bar code data input by the customer. The format of the query string is ?key1=value1&key2=value2&key3=value3 . . . &keyx=valuex. Keyx is a parameter and valuex is the value of the corresponding parameter. Query strings according to an embodiment of the present invention may include two parameters: the barcode data and the symbology of the barcode data. At stage 332 334, the control logic 116 uses the settings contained in the web application configuration file 120a to determine the names of the parameters to use. The parameter name for the barcode data is contained in the QueryStringParameterNameForBarcode setting. The parameter name for the symbology is contained in the QueryStringParameterNameForSymbologyID. For “Default.aspx”, the name of the barcode parameter is “Barcode” and the name of the symbology parameter is “SymID”. If a setting for a parameter does not exist, the control logic will include neither the parameter nor the value corresponding to that parameter in the query string. The control logic 116 uses this information and the data received from the decode logic to construct the URL. Thus, if the current web page being displayed is “Default.aspx”, the URL constructed by the control logic 116 at stage 334 would be http://StewartJ/WebScan-SampleWebApps/PriceCheckLookup.aspx?barcode=0123456789&SymID=abcd.

At stage 336, the container application 110 uses the constructed URL as part of a redirect request. The routine ends at stage 338. The container application 110 may display the requested web page using the page request routine shown in FIG. 3A to display the web page corresponding to the constructed URL.

FIG. 3C is a flowchart of a routine to handle errors in requesting a web page according to an embodiment of the present invention. At stage 320, the container application 110 has determined that the web page request was not valid and writes an exception to a log file, which the user may consult at a later time to determine the cause of the error. At stage 322, the container application 110 accesses the web application configuration file 120a and displays a failover document. The failover document is contained in the “Failover HTML” setting in the web application configuration file 120a. After a predetermined period of time, which may be set using the “Failover Delay” setting in the web application configuration file 120a, the container application 110 switches to the next server in the list under “Servers” in the web application configuration file 120a at stage 324. The container application 110 determines whether the new request using the next server is valid at stage 326. If the request is valid, normal processing resumes at stage 306 of FIG. 3A. Otherwise, the error-handling routine returns to stage 324.

FIG. 4A is a flowchart of a startup routine according to an embodiment of the present invention. Since the configuration files 120 are not part of the container application 110, the user can freely change the configuration files 120 as necessary. The user can configure the container application 110 to automatically download updated configuration files 120. With automatic downloading, the user can completely change the content of the configuration files 120 and the changes will automatically propagate to all the computing devices 100. The container application 110 will seamlessly integrate the new configuration files 120 without requiring any changes; from the user's perspective the process is transparent.

At stage 402, the container application 110 retrieves server settings from the download configuration file 120b. At state 404, the container application 110 accesses the first server on the list in the “Server” settings and attempts to download updated copies of the configuration files 120. In order to ensure that all the configuration files are the same version, a successful download may require all updated configuration files to be downloaded from the same server. If the attempt is unsuccessful, the container application 110 may execute an error-handling routine such as the one described below with respect to FIG. 4B. If the operation is successful, the container application 110 applies the settings contained within the updated configuration files in stages 406 and 408. Finally, the web application loads the start page, defined in the web application configuration file 120a. The container application 110 may now execute the page request routine described above with respect to FIG. 3A.

FIG. 4B is a flowchart of an error-handling routine for situations when an attempt to automatically download updated configuration files fails. In order to prevent conflicts between two different versions of configuration files, the container application 110 may determine that an attempt to download updated configuration files is successful when all of the updated configuration files are downloaded successfully from the same server. At stage 420, the container application 110 attempts to access the next server on the list defined in the download configuration file 120b. At stage 422, the container application 110 determines whether there are any servers left to try. If there are no more servers, the container application 110 uses the existing configuration files 120 already stored on the computing device 100 (stage 426) and resumes the normal startup routine shown in FIG. 4A at stage 406. If there is another server, the container application 110 attempts to download the updated configuration files at stage 424. If the download is successful, the normal startup routine illustrated in FIG. 4A resumes at stage 406. Otherwise, the error-handling routine returns to stage 420.

According to aspects of the present invention, the separation of functionality provided by the configuration files allows users of a computing device to develop a plafform-independent web application for the computing device without needing to know details about the particular hardware of the computing device or particular details about how to retrieve scan data from an input device. Additional aspects of the present invention enable a user to make changes without the need to rewrite the web application. The web application according to aspects of the present invention need not require the use of ActiveX controls.

According to additional aspects of the present invention, the configuration files may contain information on handling errors encountered during operation, such as failure to load a web page. Additionally, the container application may be designed to automatically download updated configuration files upon restart or at any other time. The configuration files may further contain information to handle a failure to download updated configuration files.

The techniques to separate the functionality of a web application from the interface according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc., including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus comprising:
a container application to display web pages to a customer, to receive input from an input device, and to request web pages from a web server; and
a plurality of configuration files each having user-configured settings to control the operation of the container application.

2. The apparatus according to claim 1, wherein the input is a bar code.

3. The apparatus according to claim 1, wherein the input is magnetic data from a magnetic stripe.

4. The apparatus according to claim 1, wherein the input is image data.

5. The apparatus according to claim 1, wherein the container application comprises decode logic to receive input from the input device and to decode the input into decoded data having a format usable by the container application.

6. The apparatus according to claim 5, further comprising control logic to control the container application based on the settings in the plurality of configuration files.

7. The apparatus according to claim 6, wherein the control logic comprises file transfer logic to request web pages from the web server based on the settings in the plurality of configuration files.

8. The apparatus according to claim 6, wherein the control logic comprises parsing logic to parse the plurality of configuration files.

9. The apparatus according to claim 6, wherein the control logic comprises decode redirect logic to construct a redirect request to the web server for a web page based on the decoded data received from the decode logic and on the settings in the plurality of configuration files.

10. The apparatus according to claim 6, wherein the control logic comprises failover logic to handle a failure to receive data from the web server or a failure to locate a requested web page, based on the settings in the plurality of configuration files.

11. The apparatus according to claim 1, wherein the container application comprises a web page viewer to display web pages to the customer.

12. The apparatus according to claim 1, wherein the configuration files contain settings to control automatically downloading updated configuration files.

13. The apparatus according to claim 1, wherein the configuration files contain settings to control error-handling.

14. The apparatus according to claim 1, wherein the configuration files are written in an XML (extensible markup language) format.

15. The apparatus according to claim 1, wherein the apparatus is a bar code reader.

16. The apparatus according to claim 1, wherein the apparatus is a kiosk.

17. The apparatus according to claim 1, wherein the apparatus is a handheld mobile computer.

18. The apparatus according to claim 1, further comprising a web application to provide an interface with the customer via a plurality of web pages.

19. The apparatus according to claim 11, wherein the web page viewer displays a web application comprising a plurality of web pages.

20. The apparatus according to claim 18, wherein none of the plurality of web pages requires the use of an ActiveX control.

21. The apparatus according to claim 19, wherein the apparatus does not contain any Active X controls.

22. The apparatus according to claim 18, wherein the web application is platform-independent.

23. The apparatus according to claim 1, wherein the plurality of configuration files are platform-independent.

24. A method to display a web page comprising:
loading a web page received from a web server;
determining if the web page has decode functionality enabled;
enabling decode functionality if the web page has decode functionality enabled, based on information contained in a configuration file; and
displaying the web page.

25. The method according to claim 24, further comprising:
waiting for scan input;
constructing a request for a new web page using information contained in the configuration file and the scan input; and
requesting the new web page using the constructed request.

26. The method according to claim 24, further comprising:
rendering an error document defined by a first setting in the configuration file if the loading of the web page is unsuccessful; and
loading the web page using another web server defined by a second setting in the configuration file.

27. The method according to claim 25, wherein the constructing a request comprises constructing a redirect request using information contained in the configuration file and the scan input.

28. The method according to claim 24, wherein the configuration file is platform-independent.

29. A method to provide information to a customer by separating platform-dependent functionality from platform-independent functionality, the method comprising:
decoding input from a customer;
retrieving the name of a redirect page and query string parameters from at least one platform-independent configuration file;
constructing a URL query string using the name, the parameters, and the decoded input; and
navigating to the constructed URL, wherein the web page addressed by the URL does not contain plafform-dependent code.

30. A method to automatically update configuration files stored on a computer, the method comprising:
determining the location of updated configuration files based on information contained in existing configuration files;
downloading the updated configuration files from a server listed in the existing configuration files;
applying settings contained in the updated configuration files; and
loading a web page based on information contained in the updated configuration files.

31. The method according to claim 30, further comprising:
determining if another server has the updated configuration files based on the information in the existing configuration files;
using the existing configuration files if there is no other server; and
downloading the updated configuration files using the other server if the other server does have the updated configuration files.

32. The method according to claim 30, wherein the web page does not require the use of an ActiveX control.

33. A computer readable medium comprising instructions which, when executed by a processor, cause the processor to perform the method of claim 24.

34. A computer readable medium comprising instructions which, when executed by a processor, cause the processor to perform the method of claim 25.

35. A computer readable medium comprising instructions which, when executed by a processor, cause the processor to perform the method of claim 30.

36. A computer readable medium comprising instructions which, when executed by a processor, cause the processor to perform the method of claim 31.

37. A computer readable medium comprising:
configuration files having a plurality of settings to control operation of a container application to receive scan input from an input device, to request web pages from a web server based on the scan input and the plurality of settings, and to display the web pages received from the web server; and
wherein the configuration files separate the functionality of a client apparatus from the content of the web pages so that neither the configuration files nor the web pages depend on the platform or hardware configuration of the client apparatus.

38. The computer readable medium according to claim 37, wherein the plurality of settings includes a document to be displayed by the container application in the event of a failure to load the web pages.

39. The computer readable medium according to claim 37, wherein the plurality of settings includes a name of a start web page to load when the container application starts running.

40. The computer readable medium according to claim 37, wherein the plurality of settings includes a list of servers from which the container application requests the web pages.

41. The computer readable medium according to claim 40, wherein each item in the list of servers has a corresponding virtual path.

42. The computer readable medium according to claim 37, wherein the plurality of settings comprises a plurality of page settings for a corresponding plurality of web pages.

43. The computer readable medium according to claim 42, wherein the plurality of page settings comprises a name of a web page to request upon receiving scan input.

44. The computer readable medium according to claim 43, wherein the plurality of page settings comprises names of parameters used to construct the request for the web page.

45. A computer readable medium comprising configuration files having a plurality of settings to control operation of a container application to automatically download updated configuration files onto a computer.

46. The computer readable medium according to claim 45, wherein the plurality of settings comprises a list of servers from which to download the updated configuration files.

47. The computer readable medium according to claim 46, wherein each item in the list of servers has a corresponding virtual path.

48. A computer readable medium comprising configuration files having a plurality of settings to control operation of a decoding device to decode data input by a user.

49. The computer readable medium according to claim 48, wherein the data is bar code data.

50. The computer readable medium according to claim 48, wherein the data is data contained in a magnetic stripe.

51. A system comprising:
a web server to store a plurality of web pages; and
a client apparatus including a container application to receive input data and to request web pages from the web server and a plurality of configuration files having settings to control the inputting of data and the requesting of web pages;
wherein the configuration files separate the functionality of the client apparatus from the content of the web pages so that neither the configuration files nor the web pages depend on the platform or hardware configuration of the client apparatus.

52. The system according to claim 51, further comprising a data store to store information used by the web server to respond to a request for a web page.

53. The system according to claim 52, wherein the information comprises product information.

54. The system according to claim 51, wherein the container application comprises:
logic to receive input data from a customer and to request a web page from the web server using the input data and information contained in the configuration files; and
a web application to provide an interface with the customer, wherein the web application does not depend on a particular platform supported by the container application or a particular hardware setup of the client apparatus.

55. A client apparatus comprising:
a plurality of configuration files having settings to control operations of the client apparatus;
logic to receive scan input from a customer, to determine the content of the settings in the configuration file, to construct a request for a web page using the information in the configuration file, and to request a web page using the constructed request;
wherein the configuration files and the web pages are independent of a particular platform supported by the logic and the hardware setup of the client apparatus.

56. The client apparatus according to claim 55, further comprising a web application to provide an interface to the customer, wherein the web application does not depend on a particular platform or a hardware setup of the client apparatus.

57. The apparatus according to claim 1, wherein the input is an RF tag.

58. The apparatus according to claim 1, wherein the input is a button.

59. The apparatus according to claim 1, wherein the input is a smart card.
